(19) United States
(12) Patent Application Publication
(10) Pub. No.: US 2006/0075201 A1
(43) Pub. Date: Apr. 6, 2006

(54) Hard disk device with an easy access of network

(75) Inventors: Mika Mizutani, Tokyo (JP); Yoshiaki Morimoto, Kawasaki (JP); Damien Lemoal, Sagamihara (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/237,412

(22) Filed: Sep. 27, 2005

(30) Foreign Application Priority Data
Oct. 4, 2004 (JP) 2004-290888

(51) Int. Cl. G06F 12/14; G06F 12/16

(52) U.S. Cl. 711/162; 711/112; 711/163

(57) ABSTRACT

An AV appliance mounted with a hard disk device is reinforced by assuring a home server function provided on an inherent hard disk device. The hard disk device is comprised of a hard disk, a network interface unit, a CPU, a memory and a power supply and additionally comprised of a cryptograph accelerator and a tamper-resistant area, thus offering a plug and play function, distribution of contents information stored in the hard disk device, encryption of contents through the use of a cryptograph accelerator, authentication information stored in the tamper-resistant area, authentication pursuant to an algorithm and a cooperation service with a center server.

### CLAIM OF PRIORITY

The present application claims priority from Japanese application JP2004-290888 field on Oct. 4, 2004, the content of which is hereby incorporated by reference into this application.

### FIELD OF THE INVENTION

The present invention relates to a hard disk device having a hard disk and a network interface and offering, as a common function an AV (audio-visual) appliance provided with the function to store and distribute contents exhibits, a contents server function such as storage, contents processing, Plug and Play of a network, center cooperation function and contents management/protection function. With the AV device to which the present invention is applied, digital contents having a copyright can easily be stored and transferred to another network apparatus and besides the function to maintain and back up the HDD (hard disk device) can be realized, thereby facilitating the development thereof.

### BACKGROUND OF THE INVENTION

In the field of AV appliance, digitization of broadcasting, band broadening of network and a radio network have been spread widely in use and a digital AV appliance having the storage function and network function has been said to lead in future.

Contents information expands, additionally to information of digital camera and video appliances taken by individual persons, to music contents having copyrights and map contents as well as motion picture contents commenced concurrently with start of digital broadcasting and a hard disk being cheap and having ability to store a large capacity of data as above has been mounted progressively in various kinds of AV appliances (hard disk/DVD recorder, appliance on board of the car, cellular phone and so on).

Patent Document 1, JP-A-2003-196964, presupposes a portable hard disk having a battery and a network interface unit, which hard disk can operate by itself and can perform storage and take-out of data in common with external apparatus as represented by a PC and an information home appliance.

In Patent Document 2, WO 02/17315 A2, with a view to coupling contents stored in a hard disk to applications by taking portability of a hard disk device into account, the hard disk device has a CPU, a memory and a network interface, thereby ensuring that communication with apparatus on a network through the use of HTTP (HyperText Transfer Protocol) can be made.

In Patent Document 3, US 2003/0031095 A1, a real-time OS and a file system are operated on a hard disk device having a CPU and a network interface unit to manage files on a hard disk through the medium of a network.

Disadvantageous, in the hard disk device described as above representing a storage device directly coupled to a network, care is not taken of the contents server function from standpoints of its use by general utilizers and its handling of contents having copyrights, giving rise to the following problems.

Firstly, for general utilizers to use the network function, it is important that utilization can be started without setting operation. But the mere provision of the network interface unit faces a problem that a utilizer is forced to conduct a setting operation of the network (setting of host name, server address and so on).

Secondly, in handling contents having a copyright, there arises a problem that encryption during storage, encryption during transfer through the network (network transfer) and authentication among apparatus must be carried out in consideration of protection of the copyright.

Thirdly, for the sake of realizing a common function of the hard disk device to assure maintenance/running, a problem of necessity of center cooperation function is encountered.

### SUMMARY OF THE INVENTION

The present invention intends to provide a hard disk device generally comprising a hard disk, a network interface unit, a CPU, a memory and a power supply and additionally comprising a cryptograph accelerator and a tamper-resistant area.

To solve the aforementioned first problem, software the CPU processes has a plug and play function to automatically generate an IP address and transmit contents information (a contents list) stored in the hard disk device.

To solve the second problem as above, when storing contents, the contents is encrypted using the cryptograph accelerator. Further, in case the present hard disk device is connected to a different apparatus, authentication is made in accordance with authentication information stored in the tamper-resistant area and an algorithm. Furthermore, at the time that the contents is transferred to the different apparatus, the contents is encrypted using the cryptograph accelerator and then transferred.

To solve the third problem as above, in the CPU, the center cooperation function is executed and authentication vis-à-vis with a center is made using the authentication information stored in the tamper-resistant area, thereby making use of various kinds of center services.

According to the present invention, an AV appliance mounting a hard disk device can be reinforced by assuring the home server function provided on an inherent hard disk device and hence, by utilizing the present invention, development of the AV appliance having the storage function and network function can be facilitated.

In addition, according to the invention, since a function offered through the medium of a network can be utilized, a television with hard disk and a hard disk recorder can be materialized by making cooperation with a display or a tuner having the network function and decoder function through the network.

### BRIEF DESCRIPTION OF THE DRAWINGS

FIG. 1 is a block diagram showing a hard disk device having a tamper-resistant area to exhibit the network function and copyright protection function.

FIG. 2 is a block diagram showing construction of the tamper-resistant area in the hard disk device.

FIG. 3 is a diagram showing a software structure operating on the hard disk device.

FIG. 4 is a block diagram showing a DVD/HDD recorder configured by connecting the hard disk device.

FIG. 5 is a diagram showing an example of construction of a device bridge.

FIG. 6 is a diagram showing constituent elements of a certificate.

FIG. 7 is a diagram showing a video recording process flow in the hard disk device.

FIG. 8 is a flowchart showing procedures when making authentication vis-à-vis with an apparatus to which the hard disk device connects.

FIG. 9 is a flowchart showing procedures when receiving a request from the apparatus connected with the hard disk device.

FIG. 10 is a diagram showing a reproduction process flow with the hard disk device.

FIG. 11 is a flowchart showing procedures when the hard disk device starts authentication vis-à-vis with an apparatus coupled to a network.

FIG. 12 is a block diagram showing a configuration of a home network system coupled to the hard disk device.

FIG. 13 is a diagram showing video recording/reproduction procedures realized in the home network system shown in FIG. 12.

FIG. 14 is a flowchart showing procedures when the hard disk device receives an authentication request from an apparatus coupled to the network.

### DESCRIPTION OF THE EMBODIMENTS

Embodiments of the present invention will now be described with reference to the accompanying drawings.

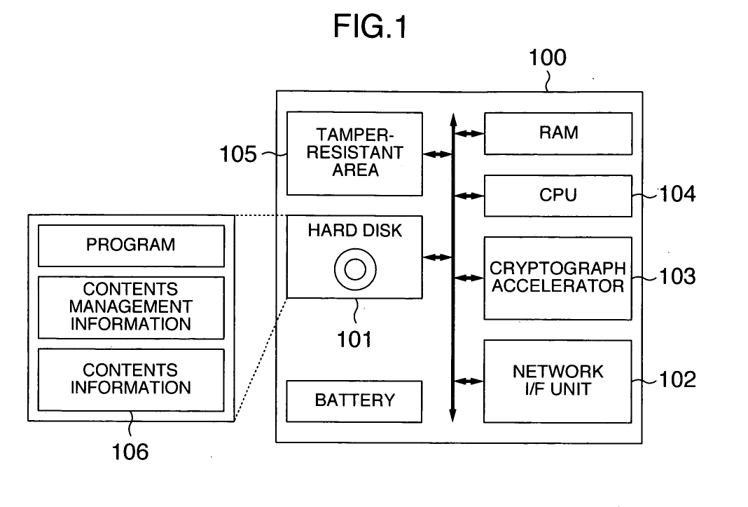

Referring first to FIG. 1, a hard disk device 100 to which this invention is applied is constructed as illustrated therein in block diagram form.

The hard disk device 100 comprises a hard disk 101, a network I/F (interface) unit 102 coupled to a network, a cryptograph accelerator 103 representing a hardware accelerator for performing encryption operation at high speeds, a tamper-resistant area 105, a CPU 104 for executing program processes of the plug and play of network, the center cooperation function and the contents server function such as contents management/protection function, and a RAM representing a memory used when executing the programs, these constituent components being coupled together by way of a bus. The device additionally comprises a battery for feeding electric power thereto.

Supposedly, the hard disk is constructed of a recording disk (platter), a spindle for rotating the recording disk with a power source motor, a read/write head, an arm/actuator for operating the head back and forth and a processor for controlling the spindle, arm and actuator but this is not limitative and structurally, control operation may be carried out with the CPU 104 of the hard disk device.

The network to be coupled is supposed to be a radio LAN such as IEEE 802.11a/g or Ethernet (registered trademark) such as IEEE 802.3 and the network I/F unit 102 carries out a physical process of the network, a frame process during transfer through transmission path such as media access control and an error correction.

The bus for coupling the individual components is not limited to a common bus as illustrated in the figure. Stored in the recording disk of hard disk 101 are programs operable on the CPU, contents information 106 and contents management information including an identifier corresponding to the contents information, a title, contents type (video, music and so on), protocol information, a file name and cryptograph information of contents. In consideration of copyright protection, the contents information 106 is encrypted and then stored on the hard disk. The cryptograph information of the contents management information may also be encrypted and then stored by taking safety guard into account.

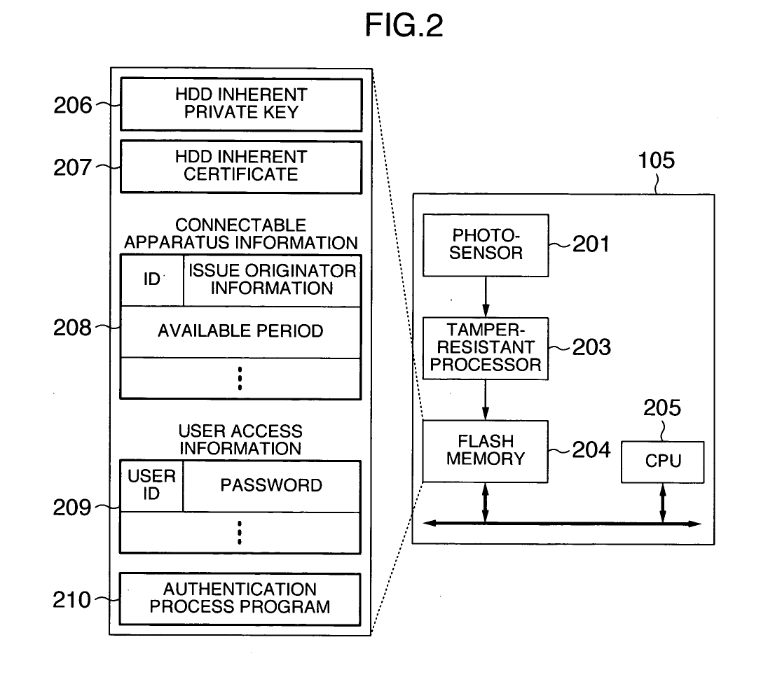

Turning to FIG. 2, there is illustrated a hardware construction of the tamper-resistant area 105. The tamper-resistant area 105 includes a flash memory 204 for storing a HDD inherent private key 206, a HDD inherent certificate 207, information of an apparatus to be connected (connectable apparatus information) 208 and user access information 209 for access control as well as an authentication process program 210 for executing an authentication process vis-à-vis with an apparatus to be connected or a user, a CPU 205 for executing the authentication process program 210, a photosensor 201 for detection of light and a tamper-resistant processor 203 for receiving a signal from the photosensor 201 or a bus monitor 202 (not shown) to erase information stored in the flash memory 204. The tamper-resistant area 105 is covered with an opaque shield such as for example a ceramic package. The tamper-resistant processor 203 incorporates a backup battery and in the event that the ceramic package is broken to cause the photosensor 201 to detect light and transmit a photodetection signal to the tamper-resistant processor 203, it acts on the backup battery to feed electric power to the flash memory 204 so as to physically destroy the information stored therein. With the hardware construction having the function as above, even in the event that part of the ceramic package is broken and a probe for read of information is so attached as to commit an unauthorized access, the authentication information on the flash memory 204 can be destroyed.

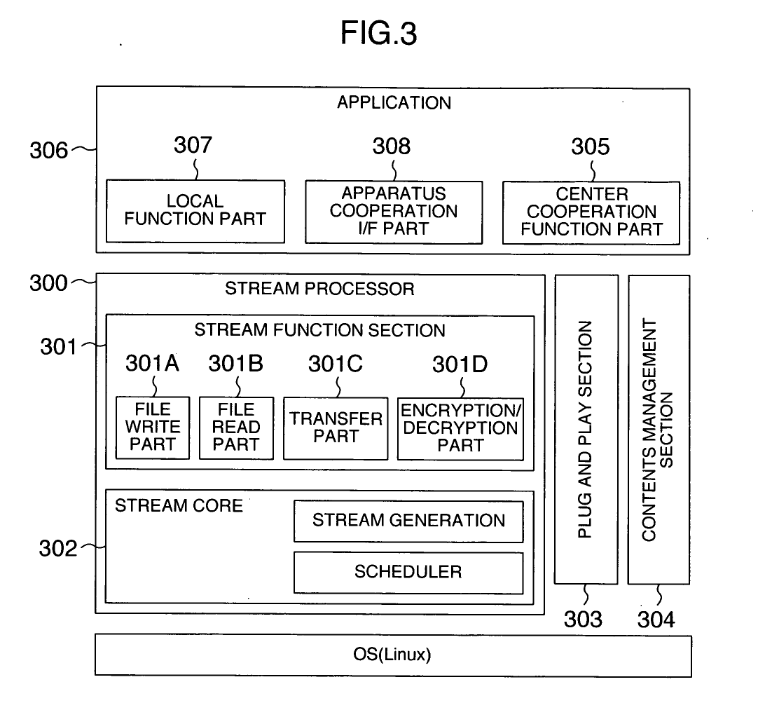

Software operating on the CPU 104 of hard disk device 100 is structured as shown in FIG. 3. In the present embodiment, the software is supposed to operate on a Linux (registered trademark) operating system.

The software includes a stream processor 300 adapted to read contents information 106 stored in the hard disk 101, transfer it to the network via the network I/F unit 102 or apply it with an encryption process in the cryptograph accelerator 103 and write contents information 106 received via the network I/F unit 102 to the hard disk 101, a plug and play function section 303 adapted to perform automatic coupling to the network and notify the network of a service presented by the present device, a contents management section 304 adapted to materialize automatic acquisition of a contents list and an application 306.

Supposedly, the function of plug and play section 303 follows, for example, a protocol called UPnP (Universal Plug and Play) prescribed by a UPnP forum to set up, without setting, a media server device provided with the contents server function representing a service of the present device so that contents information inside a local hard disk may be informed to another terminal on the network. But this is not limitative.

The application 306 includes an apparatus cooperation I/F part 308 for controlling the interface function used for connection to a terminal, a local function part 307 for performing control when the present hard disk device functions as a unity and a center cooperation function part 305 for offering a center cooperation service of backing up the information stored in the hard disk.

Next, operation of the hard disk device 100 to which the present invention is applied will be outlined. When the present hard disk device 100 is coupled to the network to start being fed with power supply, a program is read out of the hard disk 101 to commence an initial process. In the present embodiment, the program is laid on the hard disk 101 but with a view to reducing the time for start, a ROM may be provided in the hard disk device and the program may be stored on the ROM.

With the initial process completed, the following steps are proceeded with in sequence in the plug and play function section 303.

At first, an IP (Internet Protocol) address of its own is acquired through a DHCP (Dynamic Host Configuration Protocol) service prescribed in RFC2131 or an AutoIP prescribed in draft-ietf-zeroconf-ipv4-linklocak-17.txt.

Secondly, the device and service are notified to an apparatus (such as PC) on the network pursuant to UPnP (Universal Plug and Play) to show that the device is a media sever device for distributing contents information inside a local hard disk.

Next, a process the contents management section 304 executes will be described. The contents management section conducts a process for acquisition of a contents list and a process concerning update of the contents management information. In the present embodiment, the acquisition of a contents list through the network is supposed to follow AV specifications of the UPnP prescribed by UPnP forum but this is not limitative.

The contents management section receives a contents list request (for example, video) through a coupled apparatus or the network, reads a contents list concerning a video from the contents management information and returns the readout information, as contents list information, to a request originator.

The stream processor 300 includes a file read part 301B for executing a process of reading contents information 106 from the hard disk 101, a file write part 301A for executing a process of writing the contents information to the hard disk, a transfer part 301C for executing a process of transferring contents, an encryption/decryption process part 301D aiming at protection of copyrights and a stream core 302.

When distributing one piece of contents information 106, it can be carried out through, for example, 4 steps of reading the contents information 106 (file read), decrypting the contents information which has been encrypted, encrypting the contents information, while bearing its transmission through the network in mind, on the basis of cryptograph information shared by a network television of transmission destination and transferring the resultant information to the network. A series of steps as above is defined as a stream and the stream core 302 executes linkage of the individual processing parts (stream generation) and scheduling. The linkage of the individual processing parts is carried out in response to a request from the application 306.

When making a request for reproduction of contents information, stream processing procedures are undertaken as will be described below.

Firstly, the file read part 301B opens a file of contents information having a designated file name and reads it by about 512 KB. In this phase, Direct I/O is used in consideration of a reduction in read I/O time. The unit of read is about 512 KB.

Subsequently, the encryption/decryption part 301D divides the readout data into units of network transfer and annexes HTTP headers to them. Then, the cryptograph accelerator is started to decrypt a local cryptograph and encrypt a DTCP-IP. Preferably, in the case of contents information of MPEG2-TS, the unit of network transfer is a multiple of a TS packet and is 7 TS packet units, for instance.

Thereafter, the transfer part 301C opens a socket having a transmission destination of the network television and requests transmission in the unit of network transfer.

These procedures are carried out under the control of a scheduler. At the time that each process ends, the next transmission timing is calculated and the next start time is registered in the scheduler. For example, when distributing contents information of high definition TV, the contents information is delivered at an average rate of 25 Mbps and therefore, the file read needs to be started every 163 msec at the latest. In the case of the contents information of MPEG2-TS, the next processing time can otherwise be calculated using a PCR (Program Clock Reference) contained in the contents information.

At the termination of the contents information reproduction, the stream generated in the stream processor 300 is released, thus ending the process.

Next, an embodiment will be described in which the present hard disk device 100 is connected to an existing apparatus to add functions to the same.

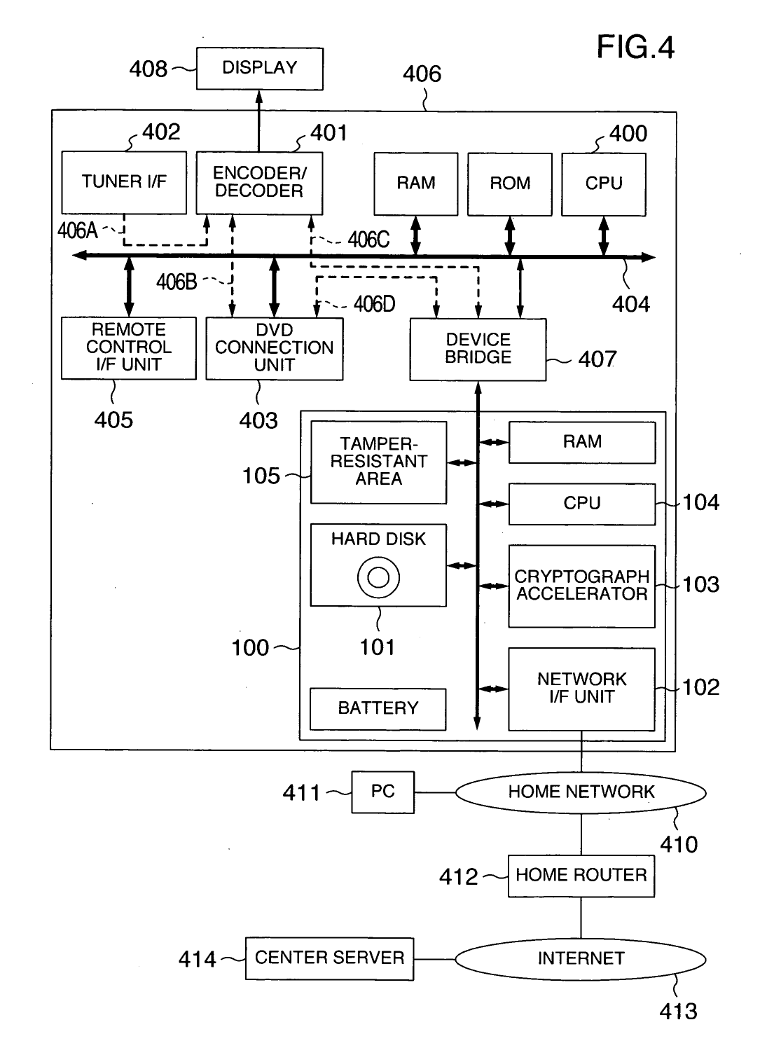

Referring to FIG. 4, there is illustrated a DVD/HDD recorder 406 configured by connecting a DVD recorder representing an existing apparatus with the hard disk device 100 to which the present invention is applied. The DVD recorder includes a DVD disk connection unit 403 for writing or reading data to or from a DVD disk, a tuner I/F 402 connectable to a tuner, an encoder/decoder 401 for decoding information read out of the DVD disk on a display and encoding a broadcast received from the tuner I/F, a remote controller I/F unit 405 for receiving a request from a remote controller a user operates, a ROM for storing programs necessary for control of GUI display, user request reception and DVD disk connection unit, a CPU 400 for execution of the programs, a memory (RAM) necessary for program operation and a device bridge 407 for connection of the hard disk device 100 to which the present invention is applied. The components as above are coupled with one another by means of a common bus 404.

Further, the DVD disk connection unit 403, encoder/decoder 401, tuner I/F 402 and device bridge 407 are coupled together through a bus 406 (406A to 406D) dedicated to data reception and transfer.

The hard disk device 100 explained in connection with FIG. 1 is coupled to the device bridge 407 of the present DVD recorder to constitute the DVD/HDD recorder 406.

In the present configuration, the tuner is provided externally but it may be built in. The device bridge 407, DVD disk connection unit 403, encoder/decoder 401 and tuner I/F 402 are coupled with one another through the medium of the bus 406 dedicated to data reception and transfer but alternatively, the common bus 404 may be utilized in place of the bus dedicated to data connection and the contents information may be encrypted using a DTCP prescribed by DTLA and then transferred.

In addition, the present DVS/HDD recorder 406 is coupled to a network 410 by way of the hard disk device 100.

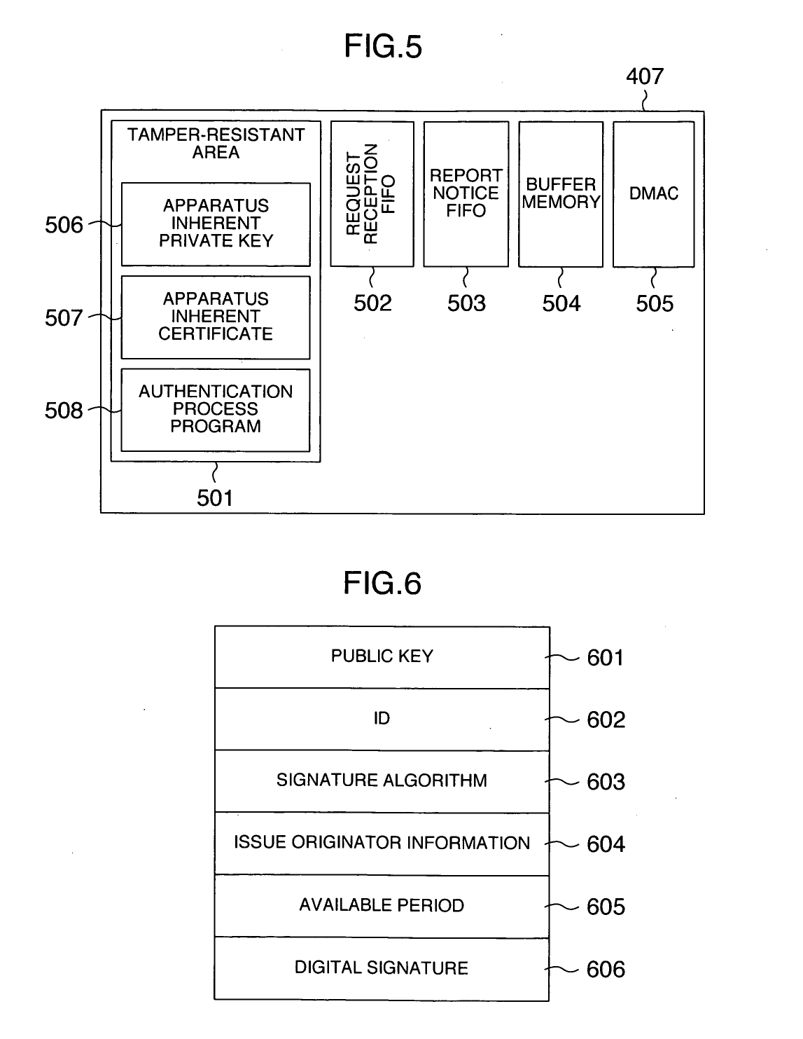

An example of construction of the device bridge 407 is illustrated in FIG. 5.

The device bridge 407 includes a tamper-resistant area 501 having an apparatus inherent private key 506, an apparatus inherent certificate 507 and an authentication process program 508, a request reception FIFO (First In First Out) 502 for transmitting a request command from the CPU 400 of the apparatus to the CPU 104 of hard disk device 100, a report notice FIFO 503 for transmitting a notice command in reverse direction, a buffer memory 504 for storing contents information and a contents list, and a DMAC (Direct Memory Access Controller)505 for transferring data between the buffer memory and the processor such as decoder/encoder 401 coupled the DMAC by means of the bus 406 dedicated to data.

Each of the request reception FIFO 502 and report notice FIFO 503 includes a plurality of areas for setting commands and command contents. The request and report are distinguishably identified in accordance with commands.

A structure of the certificate 207 or 507 is depicted in FIG. 6.

Each of the certificates 207 and 507 includes public key 601, ID (Identifier) 602, signature algorithm 603, issue originator information 604, available period 605 and digital signature 606 encrypted with a private key through the use of the signature algorithm.

Reverting to FIG. 2, the connectable apparatus information 208 and user access information 209 managed by the tamper-resistant area of hard disk device 100 are structured as shown therein.

In the present embodiment, the connectable apparatus information 208 is comprised of an ID of a certificate of an apparatus permitted to be connected, an issue originator information and an available period.

In the present embodiment, the user access information 209 is comprised of a user ID and a password.

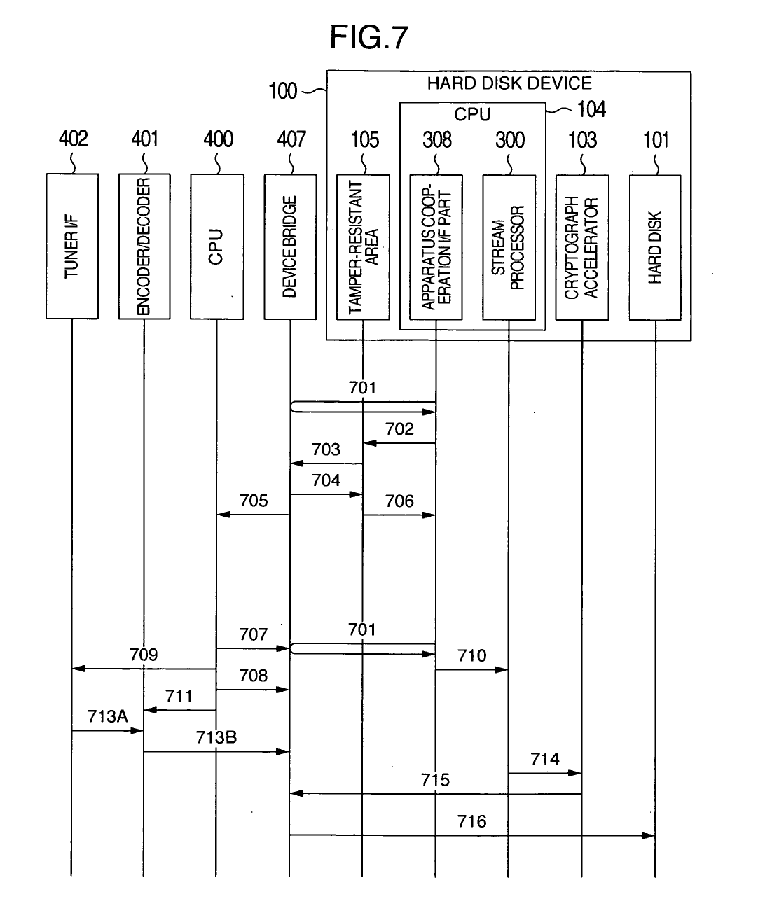

A video recording process will be described hereunder in accordance with procedures shown in FIG. 7.

Firstly, a description will be given of a process of authenticating an apparatus (DVD recorder) and the hard disk device.

When an apparatus detects a connection with the hard disk device 100, the authentication process program 508 of tamper-resistant area of the device bridge writes a request command represented by authentication request and a command content represented by apparatus inherent certificate 507 to the request reception FIFO 502.

An apparatus cooperation I/F part 308 of hard disk device 100 periodically polls the request reception FIFO 502 (701) and when receiving the request and identifying the authentication request from the request command, starts the authentication process program 210 of tamper-resistant area 105 of the hard disk device 100 (702).

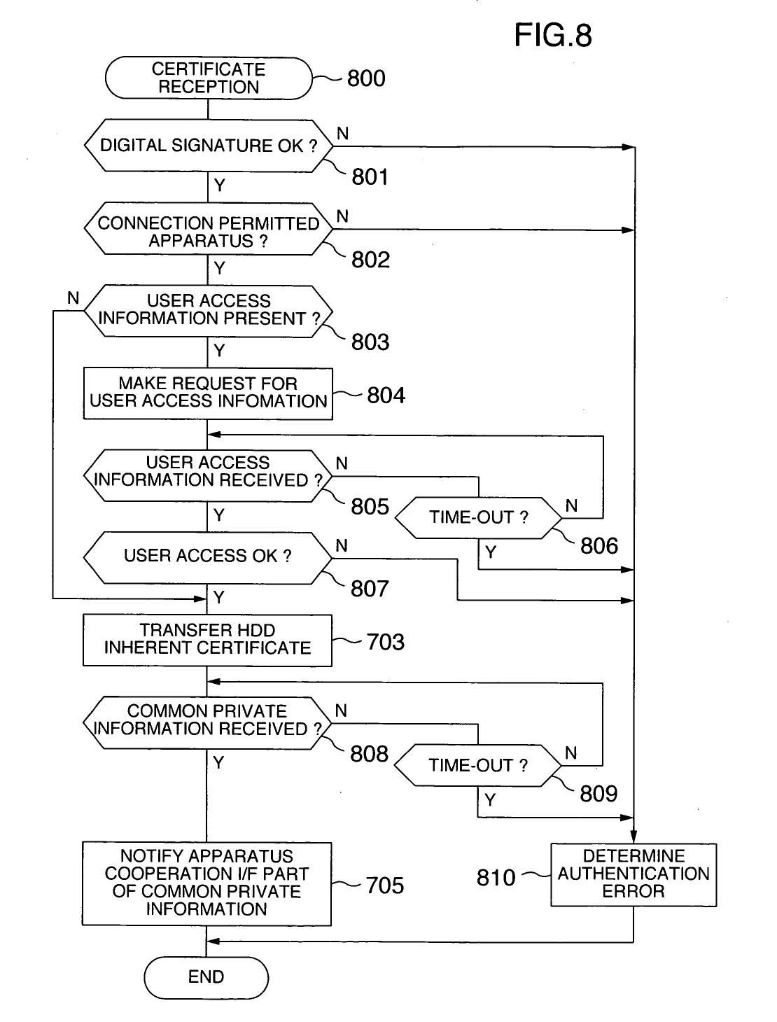

Specifically, procedures of the certificate reception process of authentication program 210 of the tamper-resistant area 105 in the hard disk device 100 will be described with reference to a flowchart of FIG. 8.

In a first step, the apparatus inherent certificate 507 is confirmed. In an exemplary method for confirmation, a value 1 resulting from Hash calculation of information other than the digital signature 606 in the certificate is compared with a value 2 resulting from decoding the digital signature 606 with the public key 601 of certificate pursuant to the signature algorithm 603 and from subjecting the result to Hash calculation and if coincident, it is further confirmed if the available period 605 is not expired (801). If the result is problematic, an authentication error is determined and the process ends (810).

In a second step, in case the connectable apparatus information 208 is set, it is confirmed if the ID 602 and issue originator information 604 in the certificate 507 coincide with values set in the connectable apparatus information 208 (802). If non-coincident, an authentication error is determined and the process ends (810).

In a third step, it is decided whether the user access information 209 is set. If not, the program proceeds to a sixth step (803).

In a fourth step, if setting is determined in the third step, the user access information is set in the report notice FIFO 503 (804). By polling the request reception FIFO 502 at a fixed period, the user access information is received (805). If the user access information cannot be procured even after a constant time has elapsed, timeout is settled to determine an authentication error and the process ends (806, 810).

In a fifth step, the user access information set in the request reception FIFO 502 is compared with the user access information 209 set on the flash memory 204 (807). If non-coincident, an authentication error is determined (810).

In the sixth step, the HDD inherent certificate 207 inside the flash memory 204 is registered in the report notice FIFO 503 (703).

In a seventh step, after completion of the certificate confirmation process on the side of CPU 400, setting of the common private information and the available period encrypted with the public key set in the HDD inherent certificate as well in the request reception FIFO (502) are waited for (808). Unless setting in the request reception FIFO (502) is completed in the constant period, an authentication error is determined and the process ends (810).

In an eighth step, the common private information set in the request reception FIFO (502) is encrypted with the HDD inherent private key 206 and is informed, together with the available period, to the apparatus cooperation I/F part 308, thereby ending the process (705).

Through the above steps, authentication is made between the apparatus and the hard disk device 100.

With the authentication error determined, the common private information and available period are not informed to the apparatus cooperation I/F part 308.

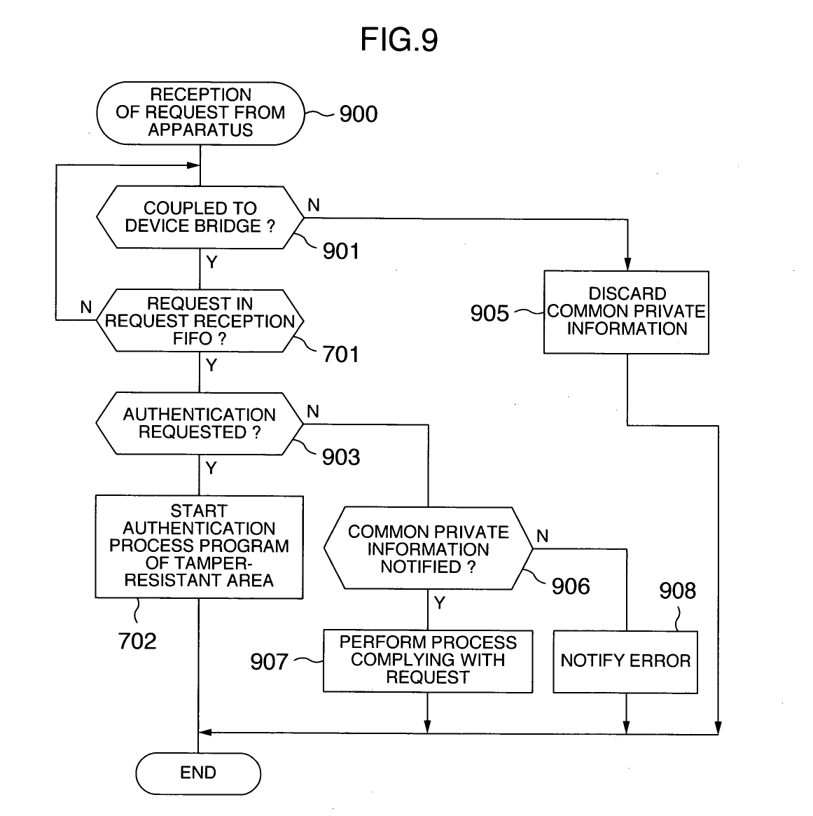

Accordingly, the apparatus cooperation I/F part follows procedures shown in FIG. 9 to deal with the case of reception of requests except for the authentication request by confirming the presence or absence of notification of the common private information (906), followed by execution of a process conforming to the request (907) when the notification is completed or by execution of a process of notifying the apparatus of an error (908) when notification of the common private information is not completed. This control operation the apparatus cooperation I/F part undertakes keeps the hard disk device from being utilized.

In addition, when monitoring of a connection of the hard disk device 100 to an apparatus shows that the connection is not made, the noticed common private information is discarded (901, 905) so that the hard disk device 100 cannot be utilized even when connected to another apparatus unless the authentication process has been completed.

Reverting to FIG. 8, as the authentication process becomes complete, the device bridge 407 notices the CPU of the common private information (705).

Receiving a video recording process request from a user by way of a remote controller, the CPU 400 registers a video recording request command in the request reception FIFO 502 of device bridge and sends the request to the hard disk device 100 (707).

In the hard disk device 100, the apparatus cooperation I/F part 308 polls the request reception FIFO 503 (701) to check the presence or absence of the request from the CPU 400 and when acknowledging the receipt of the request, the CPU 400, which has been informed of the common private information from the tamper-resistant area 105, can receive the video recording request.

The CPU sets a video recording channel of the tuner (709).

Further, the buffer memory 504 of device bridge 407 is secured, the DMAC 505 is set and transfer (713A, 713B) of broadcasting contents information from the encoder/decoder 401 to the buffer memory 504 is set (708).

The apparatus cooperation I/F part 308 in receipt of the video recording request asks the stream processor 300 to generate a stream of three steps which are a process of receiving contents from the device bridge 407, an encrypting process necessary for storage of the contents in the hard disk 101 and a process of writing encrypted contents information.

Next, details of a stream process during video recording of contents information will be described. At the moment that the capacity of contents information buffering of the buffer memory 504 reaches 512 KB, the encryption/decryption part 301D of steam function section 301 starts the cryptograph accelerator 103 to encrypt a local cryptograph (714, 715).

As soon as the local encryption has finished, a process of writing contents information to a file is started and the contents information is written to the hard disk (716).

The contents information video recording can be finished by releasing the stream generated in the stream core 302 of stream processor 300 when a stop request sent from the CPU 400 is received by the apparatus cooperation I/F part 308. As described above, the video recording process using the hard disk device 100 to which the invention is applied can be materialized.

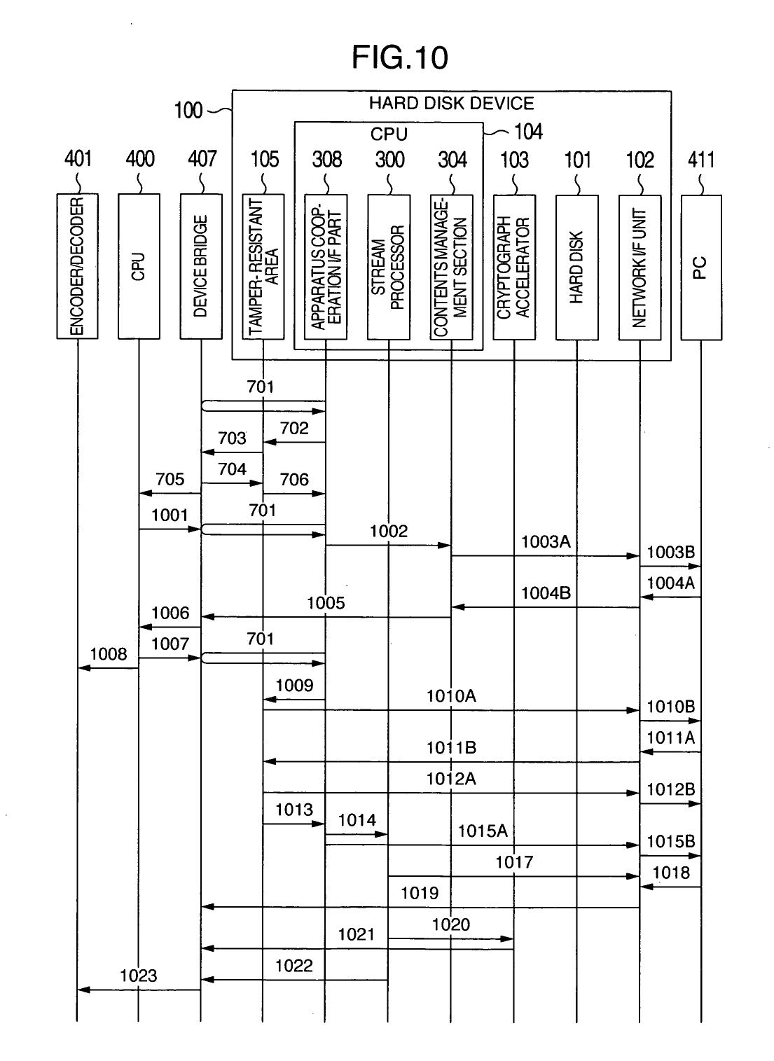

Next, a reproduction process will be described in accordance with procedures shown in FIG. 10.

The authentication process for an apparatus and the hard disk device 100 is carried out in accordance with the procedures described previously. In case the authentication process has already been completed and the common private information is shared by the apparatus and hard disk device 100 and besides the available period is valid, the present process procedure may be skipped.

Subsequently, when receiving a request for reference to a contents list from a user through a remote controller, the CPU 400 registers a reference request command in the request reception FIFO 502 of device bridge 407 and informs the hard disk device 100 of the request (1001).

In the hard disk device 100, the apparatus cooperation I/F part 308 polls the request reception FIFO 503 to check the presence or absence of the request from the CPU 400 (701).

Thereafter, the apparatus cooperation I/F part 308 assures the buffer memory 504 on device bridge 407 and asks the contents management section 304 to procure a contents list (1002). The contents management section 304 follows the UPnP AV specification to collect contents information of an apparatus having contents coupled to the network (1003, 1004). The contents management section unifies the collected contents list and a list of contents information stored in the hard disk of its own and sets a resultant list in the buffer memory 504 (1005).

Receiving a contents list acquisition completion from the contents management section 304, the apparatus cooperation I/F section 308 informs the report notice FIFO 503 inside device bridge 407 of a contents acquisition completion report together with a buffer memory address at which the contents list is set (1006).

The contents list information has an identifier corresponding to that of title.

The CPU 400 in receipt of the above notice displays the contents list on the display 408.

When the user selects contents to be reproduced from the contents list displayed on the display 408 by operating the remote controller, the CPU 400 sets an identifier of the selected contents together with the reproduction request in the request reception FIFO 502 of device bridge 407 (1007).

In the hard disk device 100, the apparatus cooperation I/F part 308 polls the request reception FIFO 502 to check the presence or absence of a request from the CPU (701). Subsequently, the apparatus cooperation I/F part 308 receiving the request for reproduction of contents information stored in its own hard disk 101 asks the stream processor 300 to generate a steam having three steps of reading contents information (file read), performing a process of decoding the contents information which has been encrypted and performing a process of transferring the contents information to the decoder.

Further, the buffer memory 504 on device bridge 407 is assured and the generated stream process is started.

Procedures in the stream processor 300 will be described. Firstly, in file read part 301B, a file of contents information having a designated file name is opened and the contents information is read by about 512 KB to the buffer memory 504. In this phase, the Direct I/O is used for reading in consideration of a reduction in read I/O time. The unit of read is set to about 512 KB.

Subsequently, the encryption/decryption part 301D causes the cryptograph accelerator 103 to be started to decrypt a local cryptograph.

Thereafter, the transfer part 301C causes the DMAC 505 of device bridge 407 to be started and the readout contents information on the buffer memory 504 is transferred to the encoder/decoder 401.

By repeating a series of procedures as above, the contents information 106 stored in the hard disk 101 can be reproduced.

In case the apparatus cooperation I/F part 308 acknowledges receipt of a request for reproduction of contents information a PC 411 on the network has, the authentication process program 210 of tamper-resistant area 105 is started in order to make authentication vis-à-vis with the PC 411 (1009).

The information of key to encryption for network transfer follows a DTCP-IP (Digital Transmission Content Protection-Internet Protocol) prescribed in DTLA (Digital Transmission Licensing Administration).

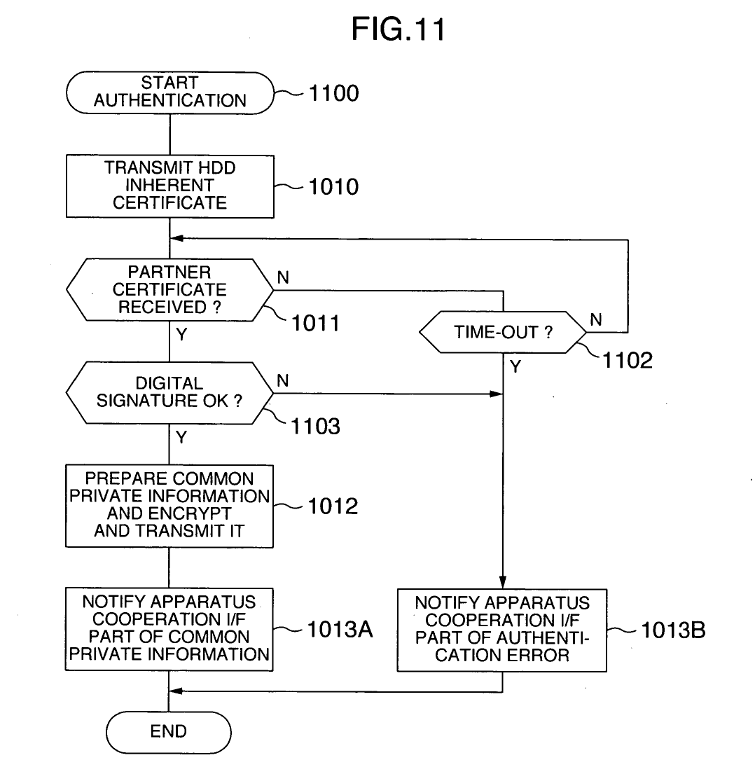

Processing procedures of an authentication process program are shown in a flowchart of FIG. 11.

In a first step, the HDD inherent certificate 2017 is sent to the PC 411 (1010).

In a second step, transmission of a certificate from the PC 411 is awaited (1011). If any certificate has not been sent before the constant wait time expires, an authentication error is determined and the process ends (1102).

In a third step, legal validity of the received certificate is confirmed through the aforementioned procedures (1103). If that certificate is problematic, an authentication error is determined and the process ends.

In a fourth step, common private information is prepared, encrypted with the HDD inherent private key 206 and then sent to the PC (1012).

In a fifth step, the common private information is informed to the apparatus cooperation I/F part 308 (1013A). In case an authentication error is determined, the authentication error is noticed to the apparatus cooperation I/F part 308 which in turn informs the report notice FIFO 503 of the reproduction error and the process ends (1013B).

In the present embodiment, the HDD inherent certificate 207 has been described as being the same as the certificated used for authentication vis-à-vis with the apparatus but a certificate for network authentication may be provided.

Subsequently, the apparatus cooperation I/F part 308 asks the stream processor 300 to generate a stream having three steps of receiving contents information, performing a process of decoding the contents information which has been encrypted and performing a process of transferring the contents information to the decoder (1014). The common private information prepared during the authentication vis-à-vis with the PC is employed for the decoding process.

The apparatus cooperation I/F part 308 informs the PC 411 of a designated file name (1015). Further, the buffer memory on device bridge is assured and a process of the generated stream is started.

Procedures in the stream processor will be described.

Firstly, the transfer section 301 is started by the stream core 302 to perform a process of receiving contents information received from the network I/F unit 102 (1017, 1018, 1019).

Subsequently, the encryption/decryption part 301D started by the stream core 302 performs a process of decoding the contents information by using the cryptograph accelerator 103. Decoding is carried out with a decoding key created from key information and common private information which are contained in the contents information. The decoded or decrypted contents information is stored in the buffer memory (1020, 1021).

As it comes to completion of storage of about 512 KB, the transfer part 301C started by the stream core 302 causes the DMAC 505 of device bridge to be started and the contents information read out onto the buffer memory 504 is transferred to the encoder/decoder 401 (1022, 1023).

By repeating a series of procedures as above, the contents information stored in the PC 411 on the network can be reproduced.

As is clear from the aforementioned embodiment, the network function and the hard disk recording/reproducing function can be offered by connecting the hard disk device 100 to the DVD recorder.

While in the present embodiment data taken over through the device bridge 407 is not encrypted, data encrypted with an encryption key prepared on the basis of common private information and information for designating an transmission originator used during the authentication process may be received and taken over. By doing so, it is possible to exclude the possibility that a hard disk device not subjected to any authentication process will be utilized when a hard disk device is exchanged after subjecting it to the authentication process. In this case, by notifying the common private information from the CPU to the encoder/decoder (711, 1008) and from the apparatus cooperation I/F part to the cryptograph process in steam processor (710, 1014), decryption/encryption of the encrypted data can be accomplished by means of the encoder/decoder 401 and cryptograph accelerator.

Next, a center cooperation function of the hard disk device 100 presented by the present invention will be described.

Returning to FIG. 4, in the system shown therein, the present hard disk device 100 coupled to the home network 410 is illustrated as being further coupled to a center server 414 on Internet 413 through a home router 412.

The center cooperation function includes a function to back up the hard disk as will be described below. In order to carry out an authentication process vis-à-vis with the center, the tamper-resistant area 105 of hard disk device 100 has a certificate and a process program for recognition procedures which are similar to those used for authentication vis-à-vis with an apparatus.

In the center cooperation function part 305, the backup function is commenced everyday at a fixed time, for example.

The center cooperation function part 305 commenced at the fixed time starts the authentication process program 210 in tamper-resistant area 105, thus initiating the authentication process vis-à-vis with the center. As has been explained in connection with FIG. 11, the tamper-resistant area 105 sends the HDD inherent certificate 207 to the center server and receives a center side certificate from the center, thus performing mutual authentication, and the tamper-resistant area in hard disk device 100 prepares common private information to transmit it to the center.

As soon as the authentication process is completed, the common private information is notified from the tamper-resistant area 105 to the center cooperation function part 305.

The center cooperation function part 305 causes the stream processor 300 to generate a stream having three steps including a process of reading (file read) information on the hard disk as a stream corresponding to the backup, performing an encryption process for preparing an encryption key on the basis of common private information shared cooperatively with the center while bearing transmission of the information through the network in mind and a process of transferring the encrypted information to the center server and sets the aforementioned cryptograph key on the encryption/decryption part. By using the thus generated stream, information on the hard disk is sequentially read in unit of, for example, 512 KB, encrypted with the cryptograph accelerator 103 and divided into units of a packet through the network I/F unit 102 so that information stored in the hard disk 101 may be transferred to the center.

Thus, various kinds of center cooperation services can be materialized including a backup service of hard disk 101 accomplished by providing the authentication process vis-à-vis the center server in the tamper-resistant area 105 and securing a safety communication path and besides, for example, an update service of software operable on the hard disk device 100 accomplished by packaging an application.

Next, an example of service realizable with the hard disk device 100 to which the present invention is applied will be described.

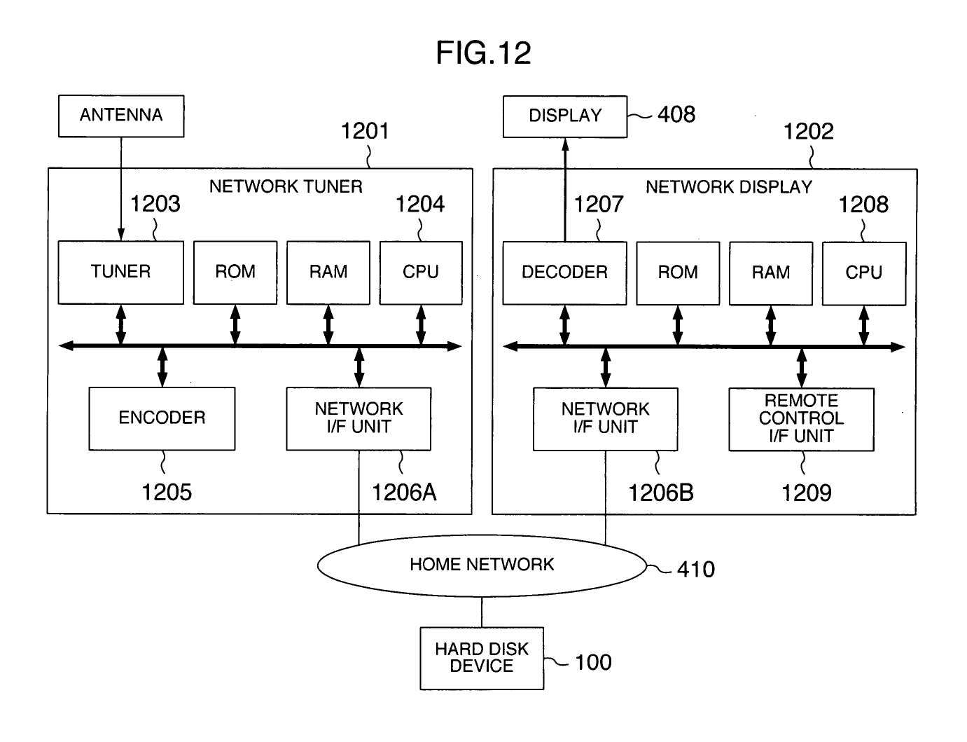

Referring to FIG. 12, a configuration of a system is illustrated in which the present hard disk device 100 is coupled to a network tuner 1201 and a network display 1202 through a home network 410.

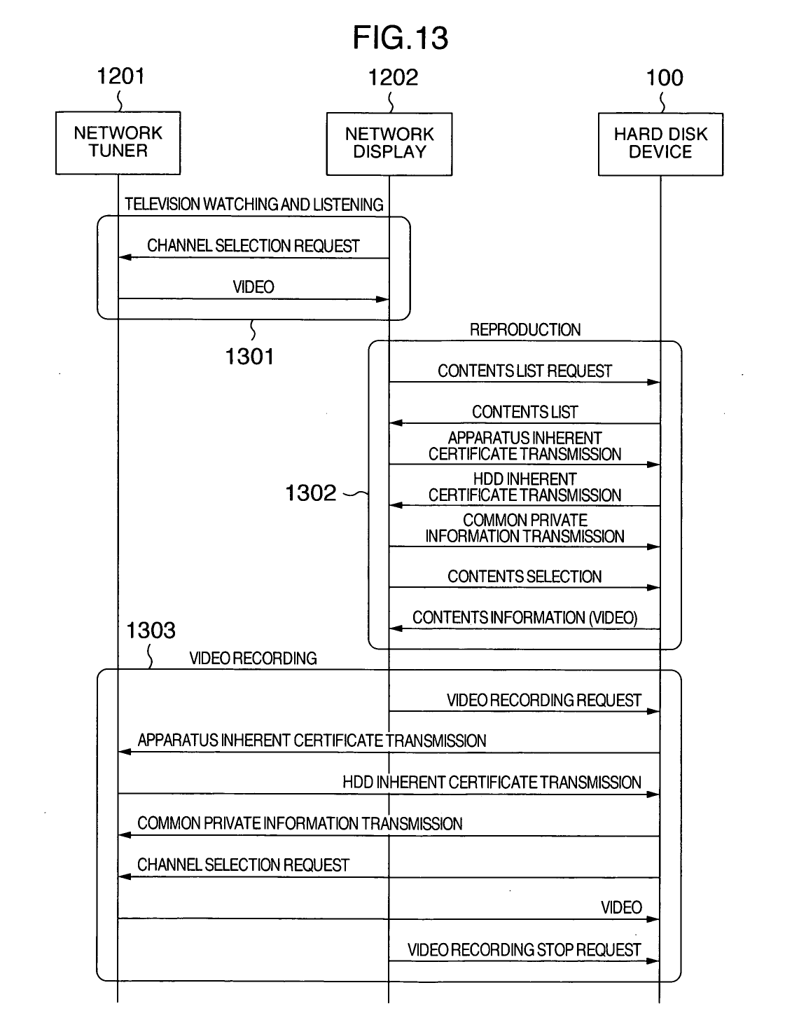

The individual components are related to one another as shown in FIG. 13 to realize service offered to users with the present system.

The network tuner 1201 includes, in addition to tuner function 1203, an encoder 1205 and a network I/F unit 1206A and operates to notify the tuner function, receive a request for selection of a channel and transmission destination information (IP address), encode a video of a designated channel and transfers it to a designated IP address. In the present network tuner 1201, a process concerning the network, for example, reception of a request and a network transmission/reception process is carried out with a program executed by a CPU 1204.

The network display 1202 is an appliance for realizing a display provided with a network function and includes a decoder 1207, a network I/F unit 1206B and a remote control I/F unit 1209, thus operating to receive a request from a user through the remote controller, ask the network tuner 1201 to select a channel, receive a video received by the network tuner 1201 by way of the network 410 to display it on a display 408 (1301) or acquire a contents list stored in the hard disk device 100 to display it on the display 408, ask the hard disk device 100 to procure contents information the user has selected from the contents list and display the received contents information on the display by way of the network 410 (1302). Alternatively, responsive to a request from the user, it records a video received by the network tuner 1201 in the hard disk device 100 (1303). In the present network display 1202, a process dealing with a user request and a process concerning the network are carried out with a program the CPU 1208 executes.

Next, service realizable with the hard disk device 100 to which the invention is applied, network display 1202 and network tuner 1201 will be described. With the present hard disk device 100 coupled to the network and power supply feed started, the programs are read out of the hard disk and an initial process is commenced. As the initial process comes to completion, the following procedures are conducted sequentially in the plug and play function section.

In a first step, an IP address of its own is acquired.

In a second step, the device and service are notified to an apparatus on the network (network television) pursuant to the UPnP to inform the apparatus that the device is a media sever device for distributing contents information into local hard disks.

A contents list request (for example, video) from the network display 408 is received by means of the contents management section, a contents list concerning videos is read out of contents management information and the thus readout information is returned as contents list information to the network television.

When making a request for contents information reproduction, the network television sends an authentication request to the hard disk device. The local function part receiving the authentication request transfers the received authentication request to the authentication process program of the tamper-resistant area and starts a process.

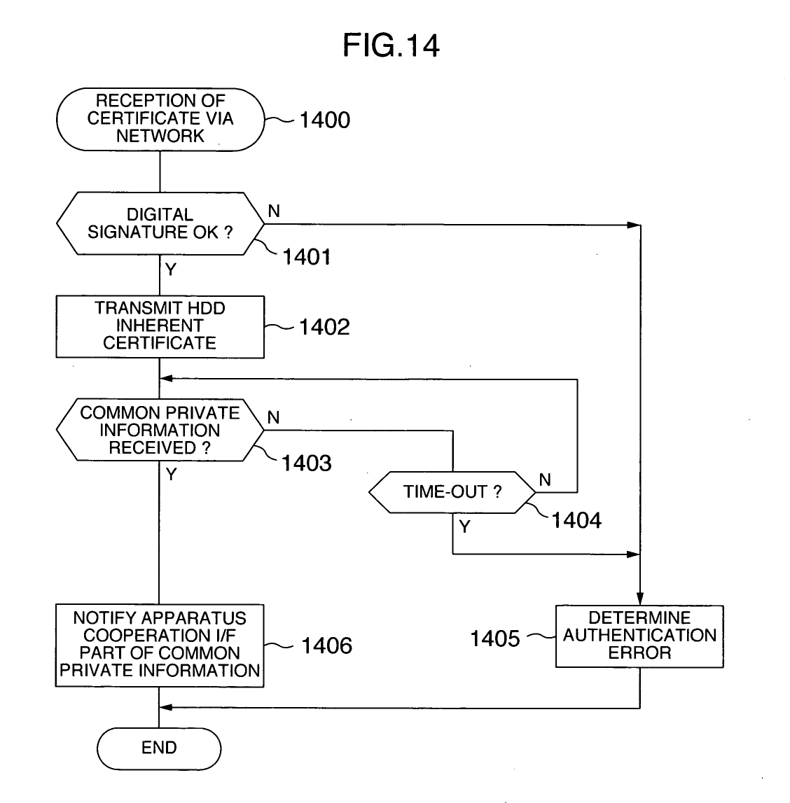

With reference to a flowchart of FIG. 14, procedures of the authentication process program will be described.

In a first step, an apparatus inherent certificate is confirmed as described previously (1401). If the certificate is problematic, an authentication error is determined and the process ends (1405).

In a second step, the HDD inherent certificate 207 inside the flash memory 204 is transmitted to the network display (1402). In a third step, common private information derived from completion of the certificate confirmation process by the network display, encrypted with a public key set in the HDD inherent certificate, or decodable with the apparatus inherent certificate and an available period are waited for (1403). If returning is not completed in a constant period (1404), an authentication error is determined and the process ends (1405). In a fourth step, the common private information and available period are notified to the local function part and the process ends (1406).

The local function part 307 receives the contents information reproduction request of network display having gone through the authentication process. The local function part 307 in receipt of the contents information reproduction request prepares a stream and transfers, as initial values, a file name to be read to the file read part 301A, address information of a transmission destination to the transfer part 301C and key information to the encryption/decryption part 301D, respectively.

The key information for decoding of the contents information 106 is managed in terms of contents management information and therefore this information is read and transferred as an initial value to the encryption/decryption part. As the key information for encryption necessary for network transfer, the common private information acquired in the authentication process is taken over.

Next, procedures of a stream process during request for reproduction of contents information will be described.

Firstly, in file read part 301B, a file of contents information having a designated file name is opened and read by about 512 KB. In this phase, reading is done using the Direct I/O in consideration of a reduction in readout I/O time. The unit of read is about 512 KB.

Subsequently, in the encryption/decryption part 301D, the readout data is divided into units of network transfer and annexed with HTTP headers. Thereafter, the cryptograph accelerator 103 is started to decrypt a local cryptograph and encrypt a DTCP-IP. Preferably, in the case of contents information of MPEG2-TS, the network transfer unit is a multiple of that of a TS packet and may for example be 7 TS packet units.

Then, in the transfer part 301C, a socket having the network television as a transmission destination is opened and transmission is requested in a unit of network transfer.

These processes are conducted under the management of the scheduler of steam core 302. In each process, at the termination of the process, the next transmission timing is calculated and the next start time is registered in the scheduler. For example, in the case of distribution of-contents information of high-vision (high definition TV) quality, an average of 25 Mbps prevails and file read must be started every 163 msec at the latest. In the case of contents information of MPEG2-TS, however, the next start time for next process can be calculated using a PCR (Program Clock Reference) contained in the contents information.

The contents information reproduction is ended by releasing the stream generated by the stream processor when the local function part receives a stop request from the network display.

As described above, the contents reproduction process 1302 can be materialized between the hard disk device 100 to which the invention is applied and the network display 1202.

A description will be given below of process procedures of contents recording 1303 the hard disk device 100 applied with the present invention undertakes by receiving a request for video recording contents from the network display.

A contents video recording request of the network display 1202 is received by the local function part 307. As the contents recording request, a video recording channel is transmitted. Receiving the contents video-recording request, the local function part 307 carries out an authentication process vis-à-vis with the network tuner 1201 in accordance with the procedures of FIG. 11 by using the authentication process program 210 of tamper-resistant area 105.

The local function part 307 in receipt of completion of the authentication process starts the stream processor 300 to cause it to generate a stream having four steps including a process of receiving a video from the network, a process of decoding necessary for network transfer, a process of encryption necessary for storage in the hard disk and a process of writing encrypted contents information.

Next, details of the stream process during contents information video recording will be described.

Firstly, in the transfer part 301C, a socket having the network tuner as a transmission originator is opened and a packet is received.

Subsequently, in the encryption/decryption part 301D, the received packet is taken over to the cryptograph accelerator where decryption of a DTCP-IP and encryption of a local cryptograph are carried out. At the moment that the contents subject to local encryption reaches 512 KB, it is written to the file in the file write part 301A.

The contents information video-recording is ended by releasing the stream generated in the stream processor 300 when a stop request transmitted from the network display 1202 is received by the local function part 307.

It will be appreciated from the above that the video recording process between the hard disk device 100 applied with the invention and the network tuner 1201 can be materialized.

As described above, by coupling the network display 1203, the network tuner 1201 and the hard disk device 100 to which the invention is applied to the network, the function of performing video recording and reproduction the HDD recorder offers can be presented by way of the network.

Having described a preferred embodiment of the invention with reference to the accompanying drawings, it is to be understood that the invention is not limited to the embodiments and that various changes and modifications could be effected therein by one skilled in the art without departing from the spirit or scope of the invention as defined in the appended claims.

1. A hard disk device comprising:
a hard disk stored with contents data and programs;
a network interface unit adapted for coupling to a network;
a CPU for executing the programs; and
a bus for coupling said hard disk device, said interface unit and said CPU,
wherein said CPU executes programs and applications which are stored in said hard disk and which exhibit functions including:
a plug and play function to couple its own apparatus to said network and notify a different apparatus coupled onto said network of contents its own apparatus offers;
a contents management function to acquire and manage a list of contents data stored in said hard disk;
a function to transfer the contents data stored in said hard disk to the network through said network interface;
a stream process function to write contents information received through said network interface to said hard disk device; and
a center cooperation function to transmit the contents data and programs stored in said hard disk to a center server coupled through said network so as to perform a backup operation.

2. A hard disk device according to claim 1 further comprising a cryptograph accelerator for performing cryptograph operations,
wherein said CPU carries out a cryptograph operation in said cryptograph accelerator.

3. A hard disk device according to claim 2 further comprising a tamper-resistant memory,
wherein said tamper-resistant memory is stored with a certificate, a private key used for encryption and an authentication process program which are used for authentication when communication is to be made with the different apparatus coupled to the network.

4. A hard disk device according to claim 3 further comprising a battery for feeding power supply to any of said hard disk, said interface unit, said cryptograph accelerator, said tamper-resistant memory and said CPU.

5. A hard disk device according to claim 3, wherein the certificate stored in said tamper-resistant memory is compared with a certificate received from the apparatus coupled through the network and when the authentication succeeds, said apparatus is permitted to access said hard disk.

6. A hard disk device according to claim 5, wherein said tamper-resistant memory is stored with user access information represented by a user identifier and a password and when a user identifier and a password acquired from said apparatus coincide with said user access information, access to said hard disk is permitted.

7. A hard disk device according to claim 6, wherein said tamper-resistant memory is connected to a tamper-resistant processor for erasing information stored in said tamper-resistant memory and said tamper-resistant processor erases said information on the basis of a signal from a photosensor for detection of light or a bus monitor for monitoring bus access to said bus.

8. A system hardware coupled to the hard disk device according to claim 1, comprising:
a device bridge coupled to the bus of said hard disk device;
an internal bus coupled to said device bridge; and
a CPU and a memory which are coupled to said internal bus,
wherein said device bridge is stored with a certificate of the system hardware and when said hard disk device is coupled and a certificate stored in said hard disk device is compared with the certificate of said system hardware to result in successful authentication, mutual communication between data on the bus of said hard disk device and data on said internal bus is made to be permissible.

9. The system hardware according to claim 8 further comprising a decoder/encoder and a tuner which are coupled to said internal bus,
wherein said device bridge reads contents from said hard disk device and transfers the readout contents to said decoder/encoder to thereby reproduce said contents.

10. The system hardware according to claim 8, wherein contents information resulting from encoding a broadcasting contents received by said tuner by means of said encoder is transferred to said hard disk device and stored therein.

11. The system hardware according to claim 8, wherein said device bridge transfers contents information said hard disk device receives through said network to said decoder/encoder so as to reproduce said contents.

12. A network system comprising the hard disk device as recited in claim 1, a display unit and a broadcasting receiver unit which are coupled with one another,
wherein said broadcasting receiver unit includes a tuner for receiving broadcasting contents and a network I/F unit for receiving request information and transmission destination information of any channel of the broadcasting contents received from said display unit and transferring them to a designated transmission destination, and
wherein said display unit includes a display for displaying the received broadcasting contents, a user I/F unit for receiving a request from a user and a network I/F unit for transmitting said request information to said broadcasting receiver unit on the basis of the request from said user.

13. The network system according to claim 12, wherein said display unit responds to the user request to acquire a contents list stored in said hard disk device so as to display it on said display and receives contents information selected by a user from said hard disk device through said network to display it on said display.

14. The network system according to claim 12, wherein said display unit responds to a user request received from a user I/F unit of said display unit to notify said hard disk device of a video recording reservation channel, and
wherein said hard disk device transmits channel information corresponding to said user request to said broadcasting receiver unit and stores broadcasting contents received from said broadcasting receiver unit via the network in said hard disk device.
